(19) United States
(12) Patent Application Publication
(10) Pub. No.: US 2014/0006114 A1
(43) Pub. Date: Jan. 2, 2014

(54) SPENDING CAPABILITY SYSTEM

(71) Applicants: Frank Anthony Nuzzi, Pflugerville, TX (US); James Brettt Sowder, Austin, TX (US)

(72) Inventors: Frank Anthony Nuzzi, Pflugerville, TX (US); James Brettt Sowder, Austin, TX (US)

(73) Assignee: EBAY, INC., San Jose, CA (US)

(21) Appl. No.: 13/537,362

(22) Filed: Jun. 29, 2012

(51) Int. Cl. G06Q 30/02

(52) U.S. Cl. 705/14.1

(57) ABSTRACT

A method for providing a spending capability includes receiving location data from a user device. A merchant location is then determined to be associated with the location data in a merchant database and, in response, at least one spending incentive that is associated with the merchant location is retrieved from the merchant database. A location balance at the merchant location is then determined using the at least one spending incentive, and a location balance indicator is provided on the user device that includes the location balance at the merchant location. The method allows a user to be dynamically informed about how much they may spend at a given location based on an amount the user may spend along with spending incentives provided by a merchant at the merchant location.

### BACKGROUND

1. Field of the Invention

The present invention generally relates to online and/or mobile payments and more particularly to a spending capability system that may be used with online and/or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Merchants may sometimes offer deals, discounts, coupons, or other spending incentives in order to incentivize customers to buy products and/or services. For example, merchants may offer a discount (e.g., an amount off, a percentage off the purchase price, “buy one get one free”, etc.) on products and/or services that allow a customer to purchase a product or service at a lower price in order to make the product and/or service more appealing to the customer for purchase. Conventionally, such discounts are provided to the customer by sending the customer a voucher or coupon that may be redeemed for the discount, providing signs at the merchant location informing the customer of the discount, and/or using a number of other traditional methods known in the art.

These traditional spending incentives attempt to inform the customer of potential savings for purchases, but do not address other customer limitations that may prevent the purchase. For example, a customer may not be able to determine how the spending incentives will apply to their desired purchase or purchases. In another example, a customer's payment account may have a low balance, and while the customer may know generally of that low balance, they may not know the exact balance. In yet another example, the customer may have a credit with the merchant that they have forgotten about. In yet another example, the customer may have saved a coupon for the merchant that they have forgotten about. As a result of these and other limitations, the customer may simply avoid the purchase even though, in some situations, those limitations should not prevent them from making the purchase.

Thus, there is a need for a spending capability system that addresses the issues discussed above.

### SUMMARY

According to one embodiment, a method for providing a spending capability includes receiving location data from a user device. The location data is used to determine a merchant location that is associated with the location data and/or at least one spending incentive that is associated with that merchant location. A location balance at the merchant location is then determined using the at least one spending incentive, and a location balance indicator that includes the location balance at the merchant location is provided on the user device.

In an embodiment, the method also includes retrieving payment account information from a user database and using that payment account information to determine the location balance at the merchant location. Thus, a location balance indicator may be provided on the user device that includes a location balance that takes into account the funds in a user payment account and at least one spending incentive associated with the merchant location.

As a result, a user may be dynamically updated with their spending capability at any particular location. For example, a user may have a payment account that includes a set amount of funds (e.g., $400), and the merchant location may be offering one or more spending incentives (e.g., 25% off any purchases) that would increase the amount the user can spend at the merchant location. Upon entering the merchant location, the user is informed of their location-based spending capability that includes the set amount of funds plus the spending incentives (e.g., $533.33, which after the 25% discount being offer at the merchant location would require the $400 set amount of funds in their payment account.)

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for making an automatic payment based on a payer location;

FIG. 2a is a front view illustrating an embodiment of a user device being used to receive location balance variables;

FIG. 2b is a front view illustrating an embodiment of a user device being used to display a location balance;

FIG. 3 is a front view illustrating an embodiment of a user device being used to display location balance details;

FIG. 4 is a front view illustrating an embodiment of a user device being used to display an updated location balance;

FIG. 5 is a schematic view illustrating an embodiment of a networked system;

FIG. 6 is a perspective view illustrating an embodiment of a payer device;

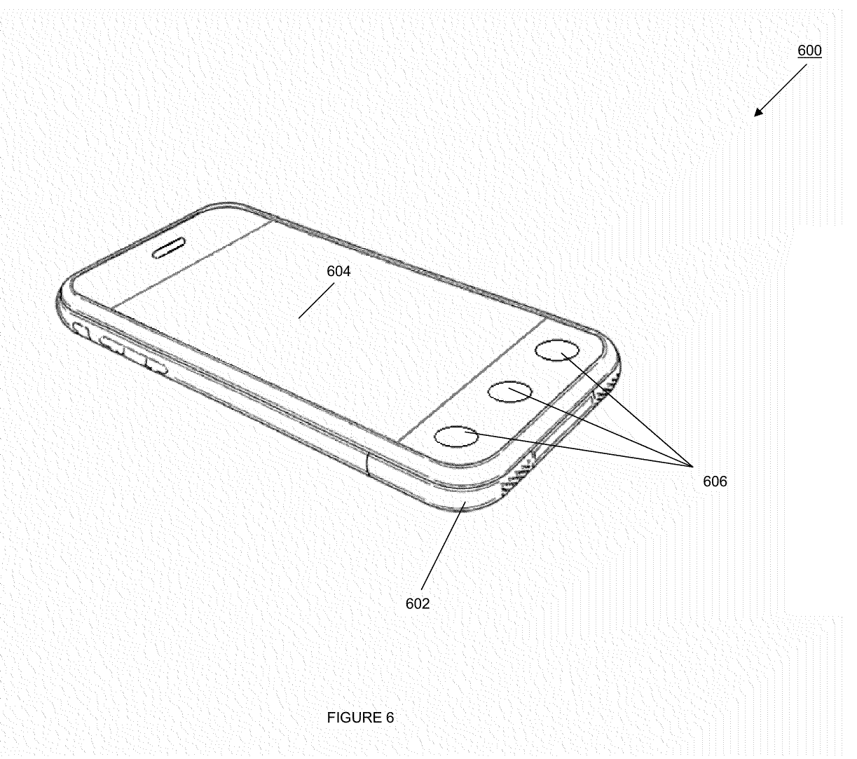

FIG. 7 is a schematic view illustrating an embodiment of a computer system; and

FIG. 8 is a schematic view illustrating an embodiment of a spending capability system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for providing a spending capability that takes into account the location of a user. A merchant may provide spending incentives that are associated with a merchant location in a merchant database. A user device that is associated with a payment account in a user database is operable to determine location data. If the location data corresponds to the merchant location in the merchant database, spending incentives that are associated with the merchant location in the merchant database are retrieved. In some embodiments, payment account information is retrieved from the payment account in the user database. A location balance that may take into account both the payment account information and the spending incentives is then determined, and the location balance is then provided on the user device such that the user of the user device will be informed of their spending capability at the merchant location.

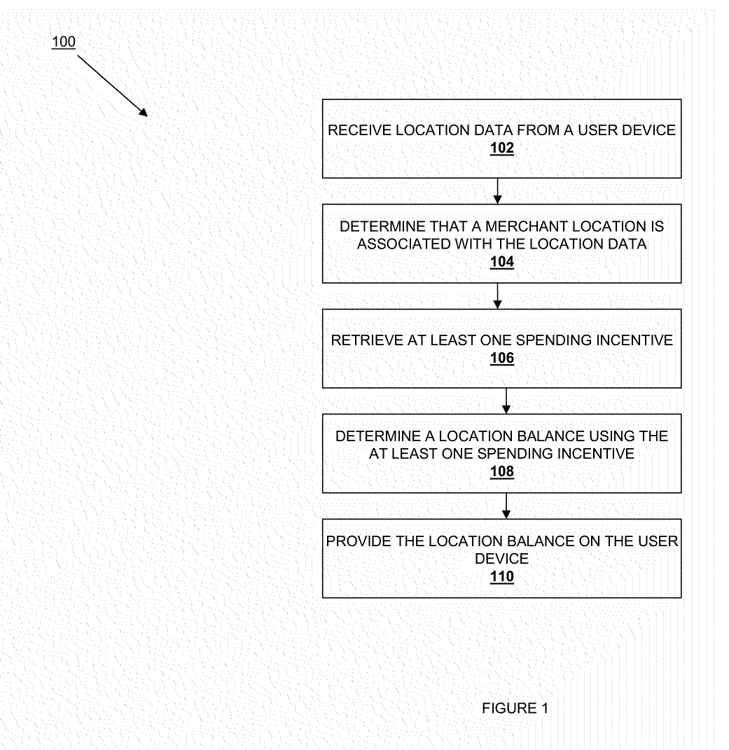

Referring now to FIG. 1, a method 100 for providing a location-based spending capability is illustrated. In the embodiment of the method 100 described below, an account provider provides a user with a payment account, and the user may use the payment account to fund payments for purchases made from merchants. In another embodiment, a payment service provider such as, for example, PayPal, Inc. of San Jose, Calif. assists in the making of payments from the user to the merchant by transferring funds from the payment account of the user to a merchant account of the merchant. In another embodiment, a third party spending capability system provider may provide the spending capability system for the user, account provider, and/or payment service provider. However, these embodiments are meant to be merely exemplary, and one of skill in the art will recognize that a variety of modifications may be made to the payment system discussed below without departing from the scope of the present disclosure.

In an embodiment, the account provider and/or the payment service provider may provide the user the payment account, and the payment account may be associated with the user in a user database (e.g., using a user identifier such as, for example, a user name.) Furthermore, the payment account may be associated with a user device or devices in the user database (e.g., using a user device identifier such as, for example, a phone number.) In some embodiments, the account provider provides the payment account to the user and include the above mentioned associations in the user database, and the payment service provider may access the user database over a network (e.g., using a payment service provider device, discussed below). As discussed in further detail below, the payment account may include payment account information about the payment account such as, for example, a payment account balance, payment account spending limits, and/or a variety of other payment account information known in the art. Furthermore, as discussed below, the user database may store a variety of other information such as, for example, previously received spending incentives, credits with merchants, etc.

In an embodiment, prior to or during the method 100, the merchant may provide one or more spending incentives for one or more merchant locations in a merchant database. For example, the merchant may use a merchant device to associate the one or more spending incentives with the one or more merchant locations in the merchant database, which may be connected directly to the merchant device or through a network to the merchant device. Furthermore, when the merchant database is connected to the merchant device over the network, the merchant database may be provided by the merchant, the account provider, the payment service provider, and/or any other spending capability system provider known in the art. As discussed in further detail below, the merchant may store a variety of other information in the merchant database such as, for example, user credits, future spending incentives, etc.

The method 100 begins at block 102 where location data is received from a user device. In the embodiments discussed below, the user includes a mobile user device such as for example, a mobile phone or other computing device, that is operable to determine location data and, in some embodiments, send that location data to the system provider device over a network. For example, at block 102, the user device may include a location determination device (e.g., a Global Positioning System (GPS) device, a cell tower triangulation device, a WiFi location determination device, and/or a variety of other location determination devices known in the art) that is operable to determine a current location of the user device, and the user device may send that current location over the network to the system provider device. In some embodiments, the user device may automatically and periodically determine the location data and, in some embodiments, send the location data to the system provider device without an action required by the user. For example, block 102 may repeatedly be performed by the user device to automatically and periodically determine the location data as the user moves from location to location with the user device, with the method 100 only proceeding to blocks 104-110 when a merchant location is determined to match that location data, discussed further below. In other embodiments, the user device may determine the location data in response to an action by the user (e.g., the launch of an application on the user device, the receipt of an instruction by the user, etc.) For example, block 102 may be performed only in response to the user instructing the user device to determine the location data (e.g., once the user has entered a merchant location.) Thus, at block 102, location data is received from the user device (e.g., by an application running on the user device, over the network by a system provider device, etc.)

Thus, the method 100 may be performed on the user device by, for example, an application running on the user device, or by a system provider device connected to the user device over the network. Therefore, in some examples of block 102 of the method 100, the application on the user device may receive the location data from the location determination device in the user device. Furthermore, in other embodiments, block 102 of the method 100 may be skipped, discussed in further detail below.

The method 100 then proceeds to block 104 where a merchant location is determined to be associated with the location data. As discussed above, the merchant may include one or more merchant locations that may be stored in a merchant database. As would be understood by one of skill in the art, the location data corresponds to a location, and thus may include coordinates on a map that may be associated with other information such as, for example, street addresses, merchant locations, landmarks, and/or a variety of other location information known in the art. At block 104 of the method 100, the system provider device may use the location data received in block 102 of the method 100 to determine that the location data is associated with a merchant location in the merchant database.

As discussed above, in another embodiment, the method 100 may be performed by the user device. For example, the application performing the method on the user device may use the location data received in block 102 of the method 100 to determine that the location data is associated with a merchant location in the merchant database, which may be stored on the user device or accessed over the network. As also discussed above, in some embodiment of the method 100, block 102 may be skipped. In those embodiments, block 104 may be modified such that the user device determines that the user device has entered a merchant location. For example, a merchant device at the merchant location may broadcast a merchant identifier or a merchant location, or that merchant device may be accessed by the user device to retrieve the merchant identifier or merchant location. Thus, at block 104, the user device may receive or retrieve the merchant identifier and use it to determine that the user device has entered the merchant location (e.g., by using the merchant identifier to find a merchant location in the merchant database), or simply receive or retrieve the merchant location. As discussed in further detail below, in some embodiments, block 104 may be skipped.

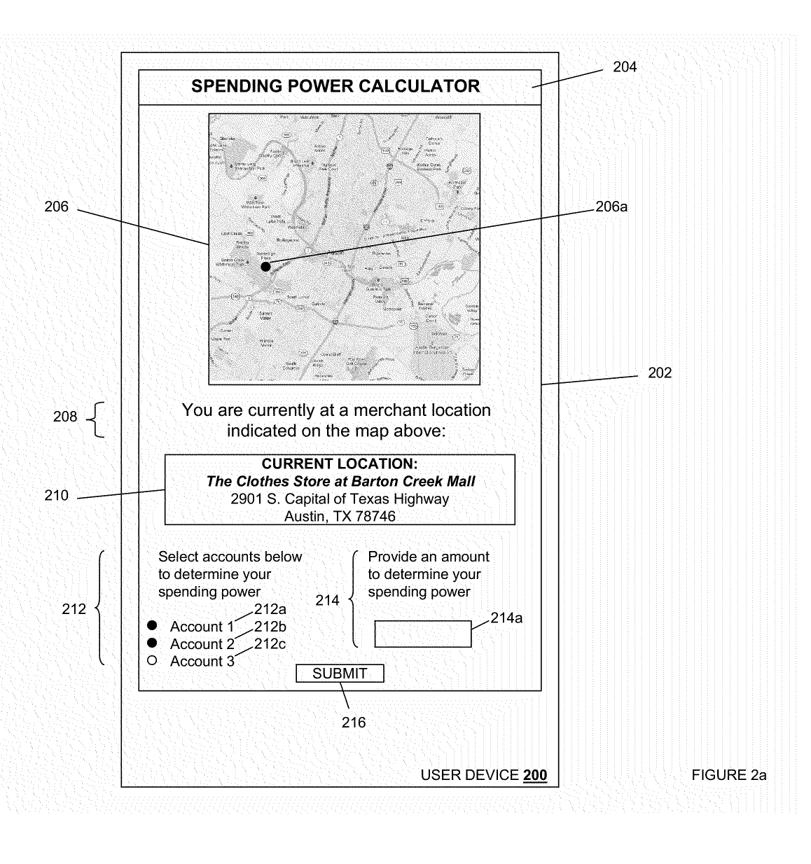

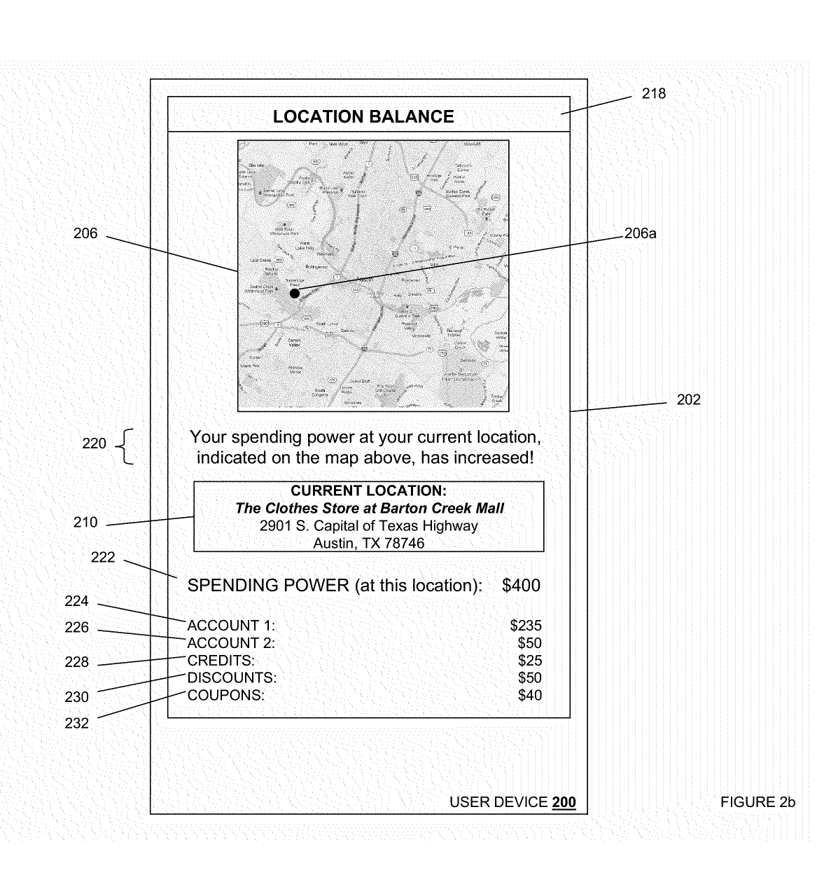

Referring now to FIG. 2a, in some embodiments of block 104 of the method 100, a spending capability start page may be provided on the user device. FIG. 2a illustrates a user device 200 including a display 202 that is displaying a spending capability start page 204. The spending capability start page 204 may be provided on the user device 200 in response to determining the merchant location in block 104 by an application in the user device, over the network by the spending capability system provider device, and/or in a variety of other manners. For example, the spending capability start page 204 may be provided on the user device as a webpage, an application screen, a “pop-up”, a text message, a picture message, and/or using a variety of other indicators known in the art. The spending capability start page 204 includes a map section 206 and a location indicator 206a that indicates the merchant location determined using the location data received in block 102 of the method 100. The spending capability start page 204 also includes a merchant location alert section 208 that indicates to the user that they are at the merchant location determined in block 104 of the method 100. The spending capability start page 204 also includes a location details section 210 that includes details about the merchant location retrieved using the location data received at block 102 such as, for example, a merchant name and merchant address.

The spending capability start page 204 may include an account selector section 212 having a plurality of accounts 212a, 212b, and 212c that the user may select in order to determine their spending capability at the merchant location. For example, the user device or the spending capability system provider device may retrieve payment account information from the user database that includes the plurality of accounts 212a, 212b, and 212c in order to display them in the account selector section 212 on the spending capability start page 204. The user may then select any of those accounts that the user wishes to include in the location balance determination, discussed in further detail below. The spending capability start page 204 may also include an location balance amount section 214 having a plurality location balance input 214a in which the user may provide an amount in order to determine their spending capability at the merchant location. For example, the user may wish to have any spending incentives at the merchant location be applied to a particular amount (e.g., the user may have the particular amount in cash, the user may see a product or service that costs the particular amount, etc.), and the user may provide that particular amount in the location balance input 214a. The user may then select a submit button 216 in order to provide the accounts and/or the location balance amount to the application in the user device or the system capability provider device over the network. As discussed below, in some embodiments, the spending capability start page 204 may not be provided, and the location balance (discussed further below) may be determined upon detection of the merchant location without any input from the user.

The method 106 the proceeds to block 106 where at least one spending incentive is retrieved. In one embodiment, the system provider device may determine that the merchant location is associated with one or more spending incentives in the merchant database and, in response, retrieve the one or more spending incentives. In some examples, the one or more spending incentives may be associated with a merchant location simply by being associated with the location data (e.g., the system provider device may retrieve the one or more spending incentives using the location data received in block 102 of the method 100.)

As discussed above, in another embodiment, the method 100 may be performed by the user device. For example, the application performing the method on the user device may use the merchant location determined in block 104 of the method 100 to retrieve one or more spending incentives that are associated with the merchant location in the merchant database, which may be stored on the user device or accessed over the network. As also discussed above, in some embodiment of the method 100, block 102 may be skipped, and block 104 may be modified such that the user device determines that the user device has entered a merchant location. In those embodiments, the user device may use the merchant location determined at block 104 to retrieve the one or spending incentives from the merchant database. As discussed in further detail below, in some embodiments, block 104 may be skipped. In those embodiments, the merchant device at the merchant location may broadcast one or more spending incentives, or that merchant device may be accessed by the user device to retrieve one or more spending incentives. Thus, at block 106, the user may enter the merchant location, and the user device may receive or retrieve one or more spending incentives from the merchant device over a network (e.g., a local area network at the merchant location.) In some embodiments, the spending capabilities start page 204, illustrated in FIG. 2a, may be provided at block 106 of the method 100 rather than block 104 in order to allow the user to provide accounts or amounts for the location balance determination, discussed herein, upon the retrieval of spending incentives from the merchant database.

In an embodiment, the spending incentives provided by the merchant may include sales, coupons, discounts, and/or other a variety of other actions or offers by the merchant to incentivize spending. For example, the merchant may be offering a percentage off any purchase at the merchant location (e.g., 25% off all purchases in the store), a percentage off particular purchases at the merchant location (e.g., 25% off purchases of pants at the store), a percentage off purchases at the merchant location above a set purchase amount (e.g., 25% off a purchase amount over $100), a percentage off an item purchased at a certain time (e.g., 25% items purchased on Monday's between 12 pm and 1 pm), a set amount off any purchase at the merchant location (e.g., $10 off all purchases in the store), a set amount off particular purchases at the merchant location (e.g., $30 off purchases of pants at the store), a set amount off purchases at the merchant location above a set purchase amount (e.g., $50 off a purchase amount over $200), a set amount off an item purchased at a certain time (e.g., $25 off items purchased on Monday's between 12 pm and 1 pm), an item free with the purchase of another item (“buy one get one free”), a percentage off an item with the purchase of another item (25% off pants with the purchase of another pair of pants), combinations thereof, and/or a variety of other spending incentives known in the art.

In some embodiments of block 106, the system provider device or the user device may retrieve spending incentives that were previously stored by the user in the user database. For example, the user may have been provided a spending incentive such as, for example, a coupon or voucher, by the merchant. In response to being provided the spending incentive, the user may have stored the spending incentive in the user database. In some embodiments, the spending incentive may be associated with the user (e.g., through a user identifier, a user device identifier, etc.) and/or the merchant (e.g., through a merchant identification, the merchant location, etc.) in the user database. Thus, spending incentives provided by the merchant that were previously stored by the user may be retrieved upon the user entering the merchant location.

In some embodiments of block 106, the system provider device or the user device may retrieve credits that were provided by the merchant to the user and stored in the merchant database. For example, the user may have returned products previously to the merchant and, in response, the merchant recorded credits for the user in the merchant database. In some embodiments, the credits may be associated with the user (e.g., through a user identifier, a user device identifier, etc.) and/or the merchant (e.g., through a merchant identification, the merchant location, etc.) in the merchant database. Thus, credits previously provided by the merchant to the user may be retrieved upon the user entering the merchant location.

The method 100 then proceed to block 108 where a location balance is determined using the at least one spending incentive. In an embodiment, the system provider device may use the one or more spending incentives received at block 106 of the method 100 to determine a location balance. For example, the system provider device may apply the spending incentives to an preset amount of money to determine the location balance (e.g., the present amount of money may be $100, and a spending incentive of 25% off any purchases may result in the determination of a location balance of $125.) In one embodiment, the preset amount of money may be a spending limit set by the user of the user device (e.g., an amount that the user is allowed to spend at any given time). For example, the user may include an account that the user is allowed to spend $500/month on, and the spending incentives may be applied to that amount rather than a total account balance (which may be much higher than the spending limit) in order to determine the location balance. In another embodiment, the user may have entered an amount to which the spending incentives will be applied (e.g., on the spending capabilities start page 204 illustrated in FIG. 2a) during the method 100. Options for how to apply the spending incentives to determine the location balance may be set by the user (e.g., through an application on the user device, through a web page provided by the system provider device, and/or in a variety of other manners known in the art.)

In another embodiment, the system provider device may access the user database to retrieve payment account information and use that payment account information along with the one or more spending incentives received at block 106 of the method 100 to determine a location balance. For example, the system provider device may use a user device identifier to retrieve a current payment account balance of a payment account (e.g., the user database may be operated by the account provider), and then apply the spending incentives to that current payment account balance to determine the location balance (e.g., e.g., the current payment account balance may be $500, and a spending incentive of $50 for purchases over $250 may result in the determination of a location balance of $550.) In some embodiments, the payment account may be provided by and usable only with the merchant, while in other embodiments, the payment account may be a general use payment account.

As discussed above, in another embodiment, the method 100 may be performed by the user device. For example, the application performing the method on the user device may use the one or more spending incentives received at block 106 of the method 100 to determine a location balance. For example, the user device may apply the spending incentives to a preset amount of money to determine the location balance (e.g., the present amount of money may be $100, and a spending incentive of 25% off any purchases may result in the determination of a location balance of $125.) In one embodiment, the present amount of money may be the spending limit set discussed above. In another embodiment, the user device may retrieve a current payment account balance of a payment account (e.g., stored on the user device, accessed over the network using a payment account identifier or user device identifier, etc.), and then apply the spending incentives to that current payment account balance to determine the location balance.

Referring now to FIGS. 1, 2, and 3, the method 100 then proceeds to block 110 where the location balance is provided on the user device. In some embodiments of block 110, the system provider device may provide the location balance over the network to the user device. In other embodiments, the user device may provide the location balance on the user device. In some embodiments, the location balance may be provided on the user device automatically (e.g., without any further action from the user) in response to receiving the location data at block 102. FIG. 2 illustrates an embodiment of the user device 200 including the display screen 202 that is displaying a location balance indicator 218 including the location balance (e.g., provided over the network by the system provider device, provided by the user device, etc.) For example, the location balance indicator 218 may be provided on the user device as a webpage, an application screen, a “pop-up”, a text message, a picture message, and/or using a variety of other indicators known in the art.

In the illustrated embodiment, the location balance indicator 218 includes the map section 206 and the location indicator 206a that indicates the merchant location determined using the location data received in block 102 of the method 100. The location balance indicator 218 also includes a location balance alert section 220 that includes information to alert the user that, due to spending incentives retrieved at the merchant location, the amount they may spend has increased. The location balance indicator 218 also includes the location details section 210 that includes details about the merchant location retrieved using the location data received at block 102 such as, for example, a merchant name and merchant address.

The location balance indicator 218 also includes a total 222 of the location balance along with a first account balance 224, a second account balance 226, a credit balance 228, a discount amount 230, and a coupon amount 232. In the illustrated embodiment, the total 222 of the location balance includes a sum of the first account balance 224, the second account balance 226, the credit balance 228, the discount amount 230, and the coupon amount 232. The first account balance 224 may include a total balance of a first account, a spending limit that has been applied to the first account, and/or a variety of other account information known in the art. The second account balance 226 may include a total balance of a second account, a spending limit that has been applied to the second account, and/or a variety of other account information known in the art. The credit balance 228 may include a total amount of credits provided to the user by the merchant associated with the merchant location (e.g., credits associated with previously returned products, credits provided by the merchant to the user in response to a merchant mistake, etc.) The discount amount 230 may include a total amount of discount spending incentives retrieved at block 106 of the method 100. The coupon amount 232 may include a total amount of coupon spending incentives retrieved at block 106 of the method 100.

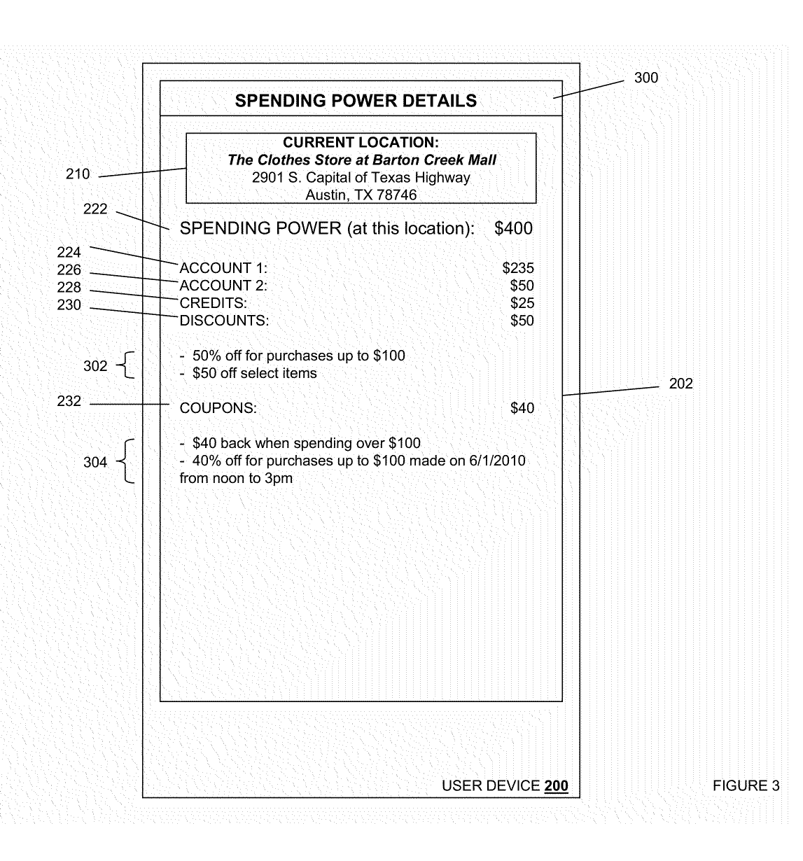

Referring now to FIG. 3, if the user of the user device 200 wishes to find out more details about the spending incentives available at the merchant location, the user may select a spending incentive (e.g., the discount amount 230 or the coupon amount 232), the total 222 of the location balance, a “details” button (not illustrated) located on the location balance indicator 218, and/or by performing a variety of other actions known in the art. In response, a spending incentive details page 300 may be provided (e.g., by the user device, from the system provider device over the network, etc.) The spending details page 300 includes the location details section 210, the total 222 of the location balance, the first account balance 224, the second account balance 226, the credit balance 228, the discount amount 230, and the coupon amount 232 that were displayed on the location balance indicator 218.

However, the spending incentives details page 300 also includes a plurality of discount amount details 302 that are provided under the discount amount 230 and a plurality of coupon amount details 304 that are provided under the coupon amount 232. Thus, in the illustrated example, the discount amount 230 includes spending incentives that provide a percentage off purchases over a set amount and a set amount off select items, and the coupon amount 232 includes spending incentives that provide a set amount back for purchases above a set amount and a percentage off purchases up to a set amount made during a set time period. The discount amount 230 may be determined by selecting one or more of the available discount spending incentives retrieved at block 106 of the method 100. In some embodiments, the discount amount 230 may be determined by selecting one of a plurality of alternative discount spending incentives, while in other embodiments, several discount spending incentives may be aggregated to determine the discount amount 230. The coupon amount 230 may be determined by selecting one or more of the available coupon spending incentives retrieved at block 106 of the method 100. In some embodiments, the coupon amount 230 may be determined by selecting one of a plurality of alternative coupon spending incentives, while in other embodiments, several coupon spending incentives may be aggregated to determine the coupon amount 230. The merchant may provide instructions in the merchant database as to which spending incentives may only be applied by themselves for any given purchase, and which spending incentives may be aggregated.

In the embodiment illustrated in FIGS. 2 and 3, the location balance indicator 218 and spending incentive details page 300 are displayed separately. However, the location balance indicator 218 may include the spending incentive details displayed on the spending incentive details page 300 without departing from the scope of the present disclosure. Furthermore, location balance indicators may include more or less information than the location balance indicator 218 illustrated in FIG. 2. While a few examples of alternative location balance indicators are discussed in detail below, one of skill in the art will recognize that a location balance indicator may include a variety of different information to indicate to a user how much they may spend at a particular location without departing from the scope of the present disclosure.

In an embodiment, a location balance indicator may only include a total and/or list of the spending incentives retrieved at block 106 of the method 100. For example, the total 222 of the location balance on the location balance indicator 218 may include the sum of the discount amount 230 and the coupon amount 232. Furthermore, discount amount details (e.g., similar to the discount amount details 302 on the spending incentives details page 300) and coupon amount details (e.g., similar to the discount amount details 304 on the spending incentives details page 300) may be included. In another example, the total 222 of the location balance on the location balance indicator 218 may include the application of the discount amount 230 and the coupon amount 232 to a preset amount or an amount provided by the user upon detecting that the user is in the merchant location (e.g., $100) in order to illustrated how the user may spend more than a given amount of money based on spending incentives being provided at the merchant location.

In an embodiment, the location balance indicator may include totals for multiple location balances, which may be based upon the different spending incentives retrieved at block 106 of the method 100. For example, some spending incentives may apply to any purchases made at the merchant locations (e.g., 25% all purchases, $50 off purchases over $100, etc.) However, some spending incentives may apply to particular purchases (e.g., 20% off jeans, $20 off winter jackets, etc.) In such a situation, a location balance indicator may include a total of a first location balance for any purchases and spending incentives that apply to that total (e.g., similar to the total 222 of the location balance on the location balance indicator 218), along with a total of a second location balance for any purchases and spending incentives that apply to that total (e.g., a total of a location balance for jeans purchases may be higher than a total of a location balance for any purchases, indicating to the user that they may even spend more if they purchase jeans at the merchant location.) Thus, several location balances may be included in the location balance indicator depending on the spending incentives retrieved at block 106 of the method 100. Furthermore, for product specific spending incentives, spending incentives for products that are inappropriate for the user may be filtered out or otherwise not included on the location balance indicator. For example, the user may provide details in the user database that indicate that the user is a male that does not ski, and thus product specific spending incentives related to women's items and skiing equipment would not be included in the location balance indicator.

In some embodiments, the user may provide or have previously provided products and/or services in the user database or the merchant database that the user is particularly interested in. In such situations, the location balance indicator may include totals for a location balance that are directed to those products and/or services. For example, a user may indicate that they are interested in snowboarding and/or are looking to purchase a particular set of snowboarding boots. If the user enters a merchant location that includes snowboarding equipment, those product and/or service preferences may be retrieved and the location balance indicator may include a total of a location balance for snowboarding equipment and/or a total for a location balance for snowboarding boots and/or the particular snowboarding boots that they user indicated they were looking to purchase.

The user device 200 may provide the user the ability to pay for any purchases made at the merchant location using methods known in the art. Thus, upon being presented with the location balance indicator at block 110 of the method 100, the user may select a product or products and/or service or services, and then use one or more of the spending incentives retrieved in block 106 of the method 100 to purchase the products or products (either using the user device or other traditional payment methods such as, for example, a physical credit card, cash, etc.)

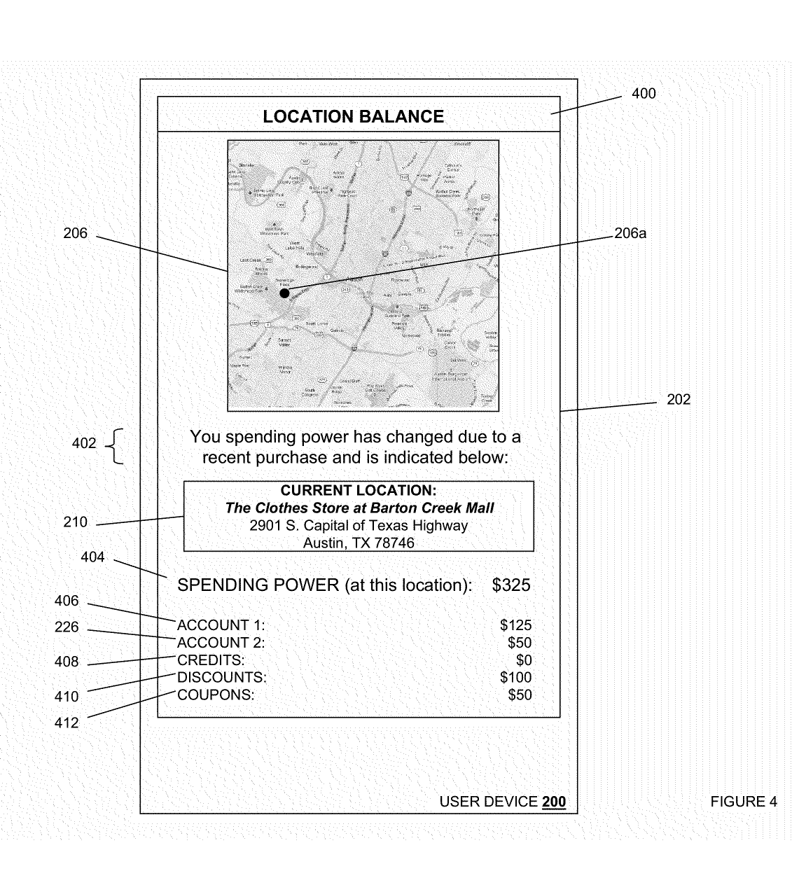

Referring now to FIG. 4, an adjusted location balance indicator 400 is illustrated that may be provided on the user device 200 subsequent to the user making a purchase at the merchant location. Upon the purchase being made by the user, the user device may retrieve, or the system provider device may provide to the user device over the network, new payment account information and new spending incentives substantially as described above. An adjusted location balance may then be determined in substantially the same manner as discussed above for the location balance in block 108 of the method 100, and the location balance indicator 400 may be provided on the user device 200 in substantially the same manner as discussed above for block 110 of the method 100. As can be seen in the illustrated embodiment, the adjusted balance indicator 400 includes the same features as the location balance indicator 218, but with an adjusted total 404 of the location balance, an adjusted first account balance 406, an adjusted credit balance 408, an adjusted discount amount 410, and an adjusted coupon amount 412.

For example, the user may have made the purchase using funds from their first account associated with the first account balance 224 (illustrated in the location balance indicator 218), credits associated with their credit balance 228 (illustrated in the location balance indicator 218), and discounts and coupons retrieved at block 106 of the method 100. New payment information retrieved subsequent to the purchase was then used to provide the adjusted first account balance 406, which in the illustrated embodiment indicates the reduced funds available in the users first account due to the purchase. Furthermore, as can be seen, new credit information retrieved subsequent to the purchase was then used to provide the adjusted credit balance 408, which in the illustrated embodiment indicates that all the users credits with the merchant have been used up. Further still, the illustrated embodiment shows how the adjusted discount amount 410 and the adjusted coupon amount 412 have actually increased relative to the discount amount 230 and the coupon amount 232 due to, for example, the merchant offering additional spending incentives (e.g., additional of discounts of $50 and additional coupons of $10) in response to the user making the purchase. However, in some embodiments, the spending incentives offered by the merchant at the merchant location may reduce (e.g., some spending incentives may only be provided for a single purchase.) Thus, the adjusted total 404 of the location balance is provided subsequent to the user purchase that takes into account new payment information, new credit information, and new spending incentives that are retrieved by or provided to the user device subsequent to the user making a purchase.

Thus, a system and method for providing a spending capability is provided that allows a merchant to offer spending incentives at a merchant location. When a user enter the merchant location with a user device, the merchant location is detected and the spending incentives are retrieved. A location balance is then determined to indicate to the user an additional spending capability that exists at the merchant location due to the spending incentives. Such systems and methods inform a user of their true spending power at any given merchant location based on spending incentives offered at that location, which allows the user to make a very accurate determination of an amount of spending they may do at the merchant location.

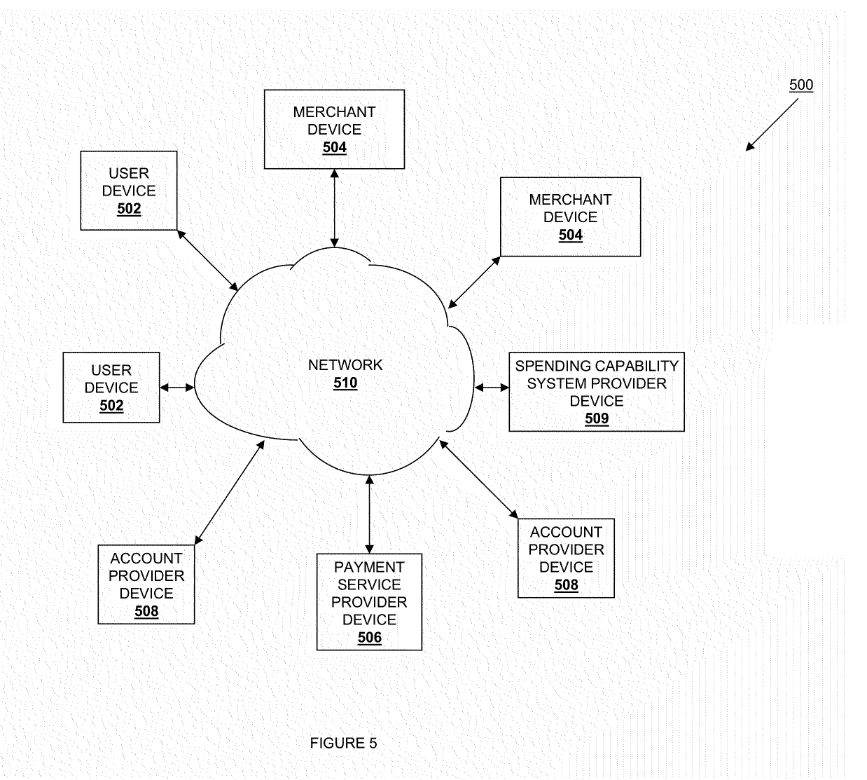

Referring now to FIG. 5, an embodiment of a networked system 500 used in the spending capability system described above is illustrated. The networked system 500 includes a plurality of user devices 502, a plurality of merchant devices 504, a payment service provider device 506, a plurality of account holder devices 508, and/or a spending capability system provider device 509 in communication over a network 510. Any of the user devices 502 may be the user device 200, discussed above. The merchant devices 504 may be the merchant devices discussed above and may be operated by the merchants discussed above. The payment service provider device 506 may be the payment service provider devices discussed above and may be operated by a payment service provider such as, for example, PayPal Inc. of San Jose, Calif. The account provider devices 508 may be the account provider devices discussed above and may be operated by the account providers discussed above such as, for example, credit card account providers, bank account providers, savings account providers, and a variety of other account providers known in the art.

The user devices 502, merchant devices 504, payment service provider device 506, account provider devices 508, and/or spending capability system provider device 509 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 500, and/or accessible over the network 510.

The network 510 may be implemented as a single network or a combination of multiple networks. For example, in various embodiments, the network 510 may include the Internet and/or one or more intranets, landline networks, wireless networks, and/or other appropriate types of networks.

The user device 502 may be implemented using any appropriate combination of hardware and/or software configured for wired and/or wireless communication over network 510. For example, in one embodiment, the user device 502 may be implemented as a personal computer of a user in communication with the Internet. In other embodiments, the user device 502 may be a smart phone, personal digital assistant (PDA), laptop computer, and/or other types of computing devices.

The user device 502 may include one or more browser applications which may be used, for example, to provide a convenient interface to permit the user to browse information available over the network 510. For example, in one embodiment, the browser application may be implemented as a web browser configured to view information available over the Internet.

The user device 502 may also include one or more toolbar applications which may be used, for example, to provide user-side processing for performing desired tasks in response to operations selected by the user. In one embodiment, the toolbar application may display a user interface in connection with the browser application.

The user device 502 may further include other applications as may be desired in particular embodiments to provide desired features to the user device 502. In particular, the other applications may include a payment application for payments assisted by a payment service provider through the payment service provider device 506. The other applications may also include security applications for implementing user-side security features, programmatic user applications for interfacing with appropriate application programming interfaces (APIs) over the network 510, or other types of applications. Email and/or text applications may also be included, which allow the user to send and receive emails and/or text messages through the network 510. The user device 502 includes one or more user and/or device identifiers which may be implemented, for example, as operating system registry entries, cookies associated with the browser application, identifiers associated with hardware of the user device 502, or other appropriate identifiers, such as a phone number. In one embodiment, the user identifier may be used by the payment service provider device 506, account provider device 508, and/or spending capability system provider device 509 to associate the user with a particular account as further described herein.

The merchant device 504 may be maintained, for example, by a conventional or on-line merchant, conventional or digital goods seller, individual seller, and/or application developer offering various products and/or services in exchange for payment to be received conventionally or over the network 510. In this regard, the merchant device 504 may include a database identifying available products and/or services (e.g., collectively referred to as items) and/or spending incentives which may be made available for viewing and purchase by the user.

The merchant device 504 also includes a checkout application which may be configured to facilitate the purchase by the payer of items. The checkout application may be configured to accept payment information from the user through the user device 502, the account provider through the account provider device 508, and/or from the payment service provider through the payment service provider device 506 over the network 510.

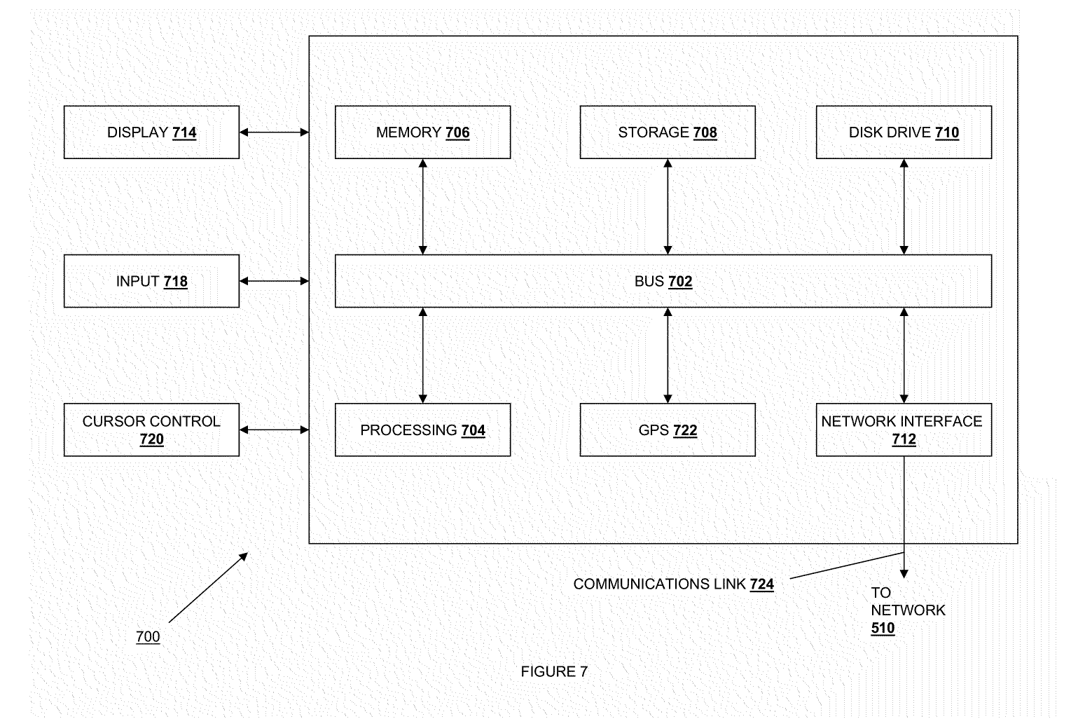

Referring now to FIG. 7, an embodiment of a user device 600 is illustrated. The user device 600 may be the user devices 200 and/or 502. The user device 600 includes a chassis 602 having a display 604 and an input device including the display 604 and a plurality of input buttons 606. One of skill in the art will recognize that the user device 600 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

Referring now to FIG. 7, an embodiment of a computer system 700 suitable for implementing, for example, the user device 200, the user device 502, the user device 600, the merchant device 504, the payment service provider device 506, the account provider device 508, and/or the spending capability system provider device 509, is illustrated. It should be appreciated that other devices utilized by users, merchants, payment service providers, account providers, and/or spending capability system providers in the spending capability system discussed above may be implemented as the computer system 700 in a manner as follows.

In accordance with various embodiments of the present disclosure, computer system 700, such as a computer and/or a network server, includes a bus 702 or other communication mechanism for communicating information, which interconnects subsystems and components, such as a processing component 704 (e.g., processor, micro-controller, digital signal processor (DSP), etc.), a system memory component 706 (e.g., RAM), a static storage component 708 (e.g., ROM), a disk drive component 710 (e.g., magnetic or optical), a network interface component 712 (e.g., modem or Ethernet card), a display component 714 (e.g., CRT or LCD), an input component 718 (e.g., keyboard, keypad, or virtual keyboard), a cursor control component 720 (e.g., mouse, pointer, or trackball), and/or a location determination component 722 (e.g., a Global Positioning System (GPS) device as illustrated, a cell tower triangulation device, and/or a variety of other location determination devices known in the art.) In one implementation, the disk drive component 710 may comprise a database having one or more disk drive components.

In accordance with embodiments of the present disclosure, the computer system 700 performs specific operations by the processor 704 executing one or more sequences of instructions contained in the memory component 706, such as described herein with respect to the user device 200, 502, and 600, the merchant device(s) 504, the payment service provider device 506, the account provider device(s) 508, and/or the spending capability system provider device 509. Such instructions may be read into the system memory component 706 from another computer readable medium, such as the static storage component 708 or the disk drive component 710. In other embodiments, hard-wired circuitry may be used in place of or in combination with software instructions to implement the present disclosure.

Logic may be encoded in a computer readable medium, which may refer to any medium that participates in providing instructions to the processor 704 for execution. Such a medium may take many forms, including but not limited to, non-volatile media, volatile media, and transmission media. In many embodiments, the computer readable medium is non-transitory. In various implementations, non-volatile media includes optical or magnetic disks, such as the disk drive component 710, volatile media includes dynamic memory, such as the system memory component 706, and transmission media includes coaxial cables, copper wire, and fiber optics, including wires that comprise the bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 700. In various other embodiments of the present disclosure, a plurality of the computer systems 700 coupled by a communication link 724 to the network 510 (e.g., such as a LAN, WLAN, PTSN, and/or various other wired or wireless networks, including telecommunications, mobile, and cellular phone networks) may perform instruction sequences to practice the present disclosure in coordination with one another.

The computer system 700 may transmit and receive messages, data, information and instructions, including one or more programs (i.e., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

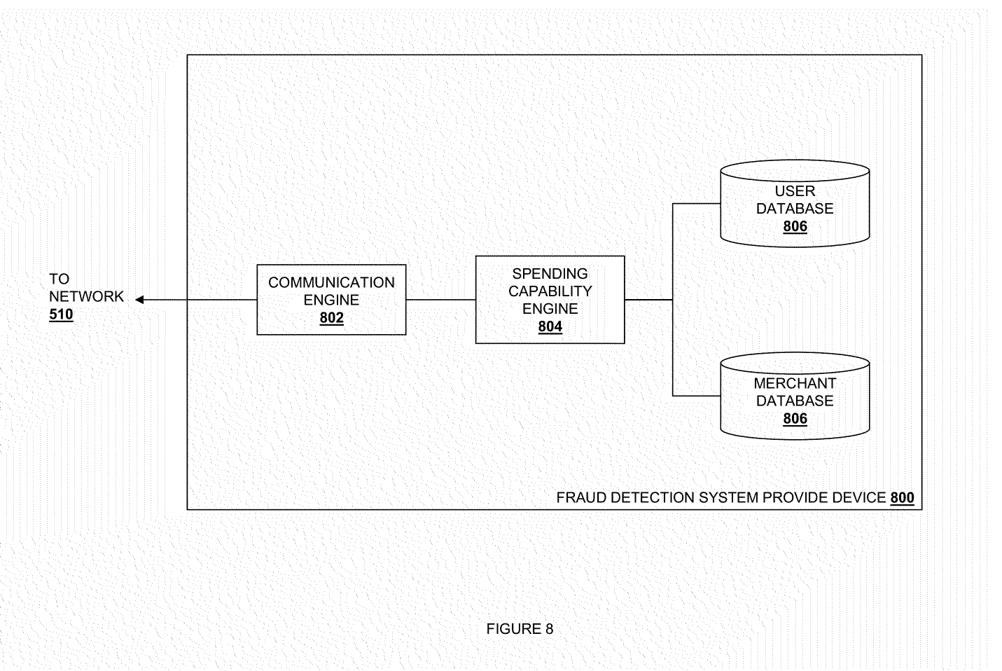

Referring now to FIG. 8, an embodiment of a spending capability system provider device 800 is illustrated. In an embodiment, the device 800 may be the user device 200, 502, and 600, the payment service provider device 506, the account holder device 508, and/or a device operated by another party. The device 800 includes a communication engine 802 that is coupled to the network 510 and to an spending capability engine 804 that is coupled to each of a user database 806 and a merchant database 808. The communication engine 802 may be software or instructions stored on a computer-readable medium that allows the device 800 to send and receive information over the network 510. The spending capability engine 804 may be software or instructions stored on a computer-readable medium that allow the device to receive location data from a user device, use the location data to determine an associated merchant location in the merchant database 808, retrieve spending incentives associated provided by the merchant and/or associated with the merchant location, retrieve payment account information over the network 510, retrieve user information from the user database 806, determine location balances at the merchant location, provide the location balance indicator on a user device, provide spending incentive details about the location balance on the user device, and/or provide any of the other functionality that is discussed above. While the databases 806 and 808 have been illustrated as located in the device 800, one of skill in the art will recognize that they may be connected to the spending capability engine 804 through the network 510 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on users and merchants; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A spending capability system, comprising:
a system provider device including one or more processors that are coupled to a memory and a network, wherein the one or more processors are operable to:
receive location data from a user device;
determine that a merchant location is associated with the location data in a merchant database and, in response, retrieve at least one spending incentive that is associated with the merchant location from the merchant database;
determine a location balance at the merchant location using the at least one spending incentive; and
provide a location balance indicator on the user device that includes the location balance at the merchant location.

2. The system of claim 1, wherein the system provider device is further operable to:
retrieve payment account information from a user database, wherein the location balance at the merchant location is determined using the payment account information.

3. The system of claim 1, wherein the system provider device is further operable to:
retrieve at least one previously stored spending incentive from a user database, wherein the location balance at the merchant location is determined using the at least one previously stored spending incentive.

4. The system of claim 1, wherein the system provider device is further operable to:
retrieve at least one credit from the merchant database, wherein the location balance at the merchant location is determined using the at least one credit.

5. The system of claim 1, wherein the system provider device is further operable to:
determine that a purchase was made at the merchant location;
determine an adjusted location balance at the merchant location using the purchase; and
provide an adjusted location balance indicator on the user device that includes the adjusted location balance at the merchant location.

6. The system of claim 1, wherein the location balance indicator includes a total of the location balance at the merchant location that is displayable on the user device, along with each of the at least one spending incentives used to determine the location balance at the merchant location that are displayable on the user device.

7. The system of claim 1, wherein the location balance indicator is automatically provided on the user device in response to receiving the location data from the user device.

8. A method for providing a spending capability, comprising:
receiving location data from a user device;
determining that a merchant location is associated with the location data in a merchant database and, in response, retrieving at least one spending incentive that is associated with the merchant location from the merchant database;
determining a location balance at the merchant location using the at least one spending incentive; and
providing a location balance indicator on the user device that includes the location balance at the merchant location.

9. The method of claim 8, further comprising:
retrieving payment account information from a user database, wherein the location balance at the merchant location is determined using the payment account information.

10. The method of claim 8, further comprising:
retrieving at least one previously stored spending incentive from a user database, wherein the location balance at the merchant location is determined using the at least one previously stored spending incentive.

11. The method of claim 8, further comprising:
retrieving at least one credit from the merchant database, wherein the location balance at the merchant location is determined using the at least one credit.

12. The method of claim 8, further comprising:
determining that a purchase was made at the merchant location;
determining an adjusted location balance at the merchant location using the purchase; and
providing an adjusted location balance indicator on the user device that includes the adjusted location balance at the merchant location.

13. The method of claim 8, wherein the spending power indicator includes a total of the location balance at the merchant location that is displayable on the user device, along with each of the at least one spending incentives used to determine the location balance at the merchant location that are displayable on the user device.

14. The method of claim 8, wherein the location balance indicator is automatically provided on the user device in response to receiving the location data from the user device.

15. A non-transitory machine-readable medium comprising a plurality of machine-readable instructions which, when executed by one or more processors, are adapted to cause the one or more processors to perform a method comprising:
receiving location data from a user device;
determining that a merchant location is associated with the location data in a merchant database and, in response, retrieving at least one spending incentive that is associated with the merchant location from the merchant database;
determining a location balance at the merchant location using the at least one spending incentive; and
providing a location balance indicator on the user device that includes the location balance at the merchant location.

16. The non-transitory machine-readable medium of claim 15, wherein the method further comprises:
retrieving payment account information from a user database, wherein the location balance at the merchant location is determined using the payment account information.

17. The non-transitory machine-readable medium of claim 15, wherein the method further comprises:
retrieving at least one previously stored spending incentive from a user database, wherein the location balance at the merchant location is determined using the at least one previously stored spending incentive.

18. The non-transitory machine-readable medium of claim 15, wherein the method further comprises:
retrieving at least one credit from the merchant database, wherein the location balance at the merchant location is determined using the at least one credit.

19. The non-transitory machine-readable medium of claim 15, wherein the method further comprises:
determining that a purchase was made at the merchant location;
determining an adjusted location balance at the merchant location using the purchase; and
providing an adjusted location balance indicator on the user device that includes the adjusted location balance at the merchant location.

20. The non-transitory machine-readable medium of claim 15, wherein the location balance indicator includes a total of the location balance at the merchant location that is displayable on the user device, along with each of the at least one spending incentives used to determine the location balance at the merchant location that are displayable on the user device.
